(19) United States
(12) Patent Application Publication
(10) Pub. No.: US 2026/0238909 A1
(43) Pub. Date: Aug. 13, 2026

(54) HEADSET FOR USE WITHIN THE INTERIOR OF A HELMET

(71) Applicant: Cardo Systems Ltd., Raanana (IL)

(72) Inventors: Avraham Kushnirov, Barkan (IL); Tamir Ventura, Tel Aviv (IL)

(21) Appl. No.: 19/424,732

(22) Filed: Dec. 18, 2025

Related U.S. Application Data
(60) Provisional application No. 63/739,301, filed on Dec. 27, 2024.

(51) Int. Cl. H04R 1/02; A42B 3/04; H04R 1/10

(52) U.S. Cl. CPC H04R 1/025; A42B 3/0406; H04R 1/1041; H04R 1/105; H04R 1/1066

(57) ABSTRACT

A headset for use with helmets includes first and second communication units coupled by a compliant connector that elastically deforms within a helmet interior to bias the communication units toward interior surfaces for stable retention. In some embodiments the connector is telescopic; in others it includes a spring. Additional features can include a microphone, a wireless communications unit, a battery, and a protective sheath. Also disclosed is a headset system configured for external attachment to helmet straps, including an enclosure that receives a communication unit via a snap-fit or friction-fit, a strap organizer with guides, and one or more fastener straps that form a back loop to secure the assembly to helmet straps. Optional elements include a tongue with a notch for Y-type straps and a keyhole opening to improve sound transmission. These configurations provide secure, adaptable audio or communication capability across a range of helmet types and use conditions.

### PRIORITY APPLICATIONS

This application claims priority to U.S. provisional application 63/739,301 filed on Dec. 27, 2024 entitled A HEADSET FOR USE WITHIN THE INTERIOR OF A HELMET, the contents of which are incorporated herein by reference.

### TECHNICAL FIELD

The present disclosure relates generally to communication devices configured for use with helmets, such as safety helmets for sports or occupational applications.

### BACKGROUND

Helmets are widely used in activities such as cycling, skating, skiing, snowboarding, construction, industrial work, and military operations. In many of these environments, users desire audio functionality—such as communication, navigation prompts, or media playback—while still wearing a protective helmet. Achieving this goal can be challenging due to limited space inside the helmet, variability in helmet construction, and interference between the helmet and the user's ears.

Portable audio devices such as earbuds and traditional headsets are not specifically configured for use inside helmets and may become displaced during movement or when a helmet is worn. Some helmet communication systems have been proposed, but these may rely on rigid mounting arrangements, require specialized helmet modifications, or may not consistently position audio components close to the user's ears. Certain external mounting devices exist, but they may shift during use, interfere with helmet retention straps, or result in inconsistent audio transmission.

There remains a need for headset systems that can be used with a wide variety of helmet types, both with internal mounting and external attachment options, while maintaining stable positioning relative to the user's ears. There is also a need for such systems to be easy to install and remove without requiring permanent helmet modification, and to provide consistent audio performance under dynamic conditions.

### SUMMARY

In various embodiments, headset systems are provided for use with helmets. In certain implementations, a headset includes first and second earpieces connected by a compliant connector that is configured to deform when positioned inside a helmet and to generate a restorative bias that maintains the earpieces in stable proximity to a user's ears. The compliant connector may return toward a pre-installation shape when removed from the helmet, permitting repeated installation without tools or permanent helmet modification. The headset may include additional components such as a microphone, a wireless communication module, user interface elements, or a power source, and may be configured for use across a range of helmet types.

In some embodiments, the compliant connector includes a telescoping structure, a spring assembly, a segmented arm, or another structure configured to permit elastic deformation in one or more directions. A protective sheath may optionally enclose all or part of the compliant connector to shield internal components and retain wiring or conductors.

Also disclosed are embodiments of headsets configured for external attachment to helmet straps. In certain examples, a headset assembly includes an enclosure that receives an earpiece and couples to one or more helmet straps using one or more fastener straps and a strap organizer. The fastener straps may form one or more loops that secure the assembly to the helmet straps without slipping or requiring permanent modification. Optional features of these embodiments may include a tongue configured to interface with strap junctions, a sound transmission opening, or removable interface pads for user comfort.

These and other embodiments described herein provide flexible, adaptable headset options for use with helmets, enabling stable audio performance while accommodating variations in helmet design and user preference.

Unlike prior art solutions, such as externally mounted speakers (e.g., U.S. Pat. No. 9,060,221) or internally fixed speakers (e.g., U.S. Pat. No. 6,970,691), which lack elastic deformation for internal securing, or strap-mounted systems (e.g., U.S. Pat. No. 8,706,043) without internal compliance, the present invention uniquely combines an elastically deformable internal connector with an external strap-based mechanism. This dual approach, configurable for mono or stereo modes, enables secure, reliable audio delivery or communication across diverse helmet applications, addressing unmet needs in sports, occupational, and recreational settings.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. Additional aspects, alternatives and variations as would be apparent to persons of skill in the art are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### BRIEF DESCRIPTION OF DRAWINGS

The invention can be better understood with reference to the following figures. The components within the figures are not necessarily to scale, emphasis instead being placed on clearly illustrating example aspects of the invention. In the figures, like reference numerals designate corresponding parts throughout the different views and/or embodiments. Furthermore, various features of different disclosed embodiments can be combined to form additional embodiments, which are part of this disclosure. It will be understood that certain components and details may not appear in the figures to assist in more clearly describing the invention.

FIG. 1A is a top view of a first embodiment of the headset in a compact configuration.

FIG. 1B is a side view of the first embodiment in a compact configuration.

FIG. 1C is a top view of the first embodiment in an expanded configuration.

FIG. 1D is a side view of the first embodiment in an expanded configuration.

FIG. 1E illustrates the first embodiment installed within a helmet.

FIG. 1F is a top view of the first embodiment in a compact configuration with a data/power line.

FIG. 1G is a side view of the first embodiment in a compact configuration with a protective sheath.

FIG. 1H is a top view of the first embodiment in an expanded configuration with a data/power line.

FIG. 1I is a side view of the first embodiment in an expanded configuration with a protective sheath.

FIG. 2A is a top view of a second embodiment in an expanded configuration.

FIG. 2B is a side view of the second embodiment in an expanded configuration.

FIG. 2C compares the second embodiment in compact configuration to the first embodiment.

FIG. 2D compares the second embodiment in expanded configuration to the first embodiment.

FIG. 2E illustrates the second embodiment installed within a helmet.

FIG. 3A is a top view of a third embodiment.

FIG. 3B is a side view of the third embodiment.

FIG. 3C is a side view of the third embodiment in a folded configuration.

FIG. 3D illustrates the third embodiment installed within a helmet.

FIG. 4A illustrates the initial installation of the first embodiment into an earpiece pocket.

FIG. 4B illustrates the final installation of the first embodiment with both earpieces in pockets.

FIG. 5 illustrates the first embodiment installed over the helmet crown, outside pockets.

FIG. 6 illustrates the first embodiment installed over the helmet skull base, outside pockets.

FIG. 7A is a front view of a headset system with enclosure, strap organizer, and fastener straps.

FIG. 7B is a side perspective view of the headset system of FIG. 7A.

FIG. 7C is a rear view of the headset system of FIG. 7A showing a back loop and keyhole cutout.

FIG. 7D is a back perspective view showing the back loop and fastener surfaces.

FIG. 8A is a top perspective of the enclosure and strap organizer.

FIG. 8B is a side view of the enclosure and strap organizer.

FIG. 8C is a rear view of the assembled enclosure and strap organizer.

FIG. 8D is a front view of a flexible enclosure overlay.

FIG. 8E is a side view of the flexible enclosure overlay.

FIG. 8F is an isometric exploded view of an enclosure with a windscreen and a windscreen cage/support.

FIG. 8G is cavity-side isometric view of the enclosure of FIG. 8F assembled.

FIG. 8H is side isometric view opposite the cavity of the enclosure of FIG. 8F assembled.

FIG. 8I is a bottom view of the enclosure with slotted microphone apertures.

FIG. 8J is a bottom view of the enclosure with slotted microphone apertures and a microphone windscreen.

FIG. 8K is a top perspective of the enclosure with a microphone windscreen support and windscreen.

FIG. 8L is a top perspective of the enclosure with a microphone windscreen.

FIG. 8M is a top perspective of the enclosure with a microphone windscreen. FIG. 9A is a front view of the headset assembly with earpiece outside the enclosure.

FIG. 9B is a top perspective view of the headset assembly with earpiece outside.

FIG. 9C is a top view of an earpiece.

FIG. 9D is a top perspective view of the earpiece of FIG. 9C.

FIG. 9E is a side perspective view of the earpiece of FIG. 9C.

FIG. 9F is a side perspective view of an opposite-ear earpiece.

FIG. 9G illustrates an enclosure with the three-piece windscreen.

FIG. 9H illustrates the communication unit installed on the enclosure of FIG. 9G.

FIG. 10A shows the headset assembly with fastener straps forming a back loop.

FIG. 10B schematically illustrates fastener surfaces.

FIG. 11 shows initial installation on a Y-type helmet strap.

FIG. 12A is a perspective view of the installed headset system (helmet omitted).

FIG. 12B is a front perspective view of the installed headset system on Y-type straps.

FIG. 12C is a side perspective view of the installed headset system outside the ear flap.

### DETAILED DESCRIPTION

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. On the contrary, it is intended to cover alternatives, modifications, and equivalents as may be included within the spirit and scope of the invention as defined by the appended claims.

In the following description, numerous specific details are set forth to provide a thorough understanding of the present invention. Example embodiments of the present invention may be implemented without some or all these specific details. In other instances, process operations well known to persons of skill in the art have not been described in detail in order not to obscure unnecessarily the present invention. Various techniques and mechanisms of the present invention will sometimes be described in a singular form for clarity. However, it should be noted that some embodiments include multiple iterations of a technique or multiple mechanisms unless noted otherwise. Similarly, various steps of the methods shown and described herein are not necessarily performed in the order indicated, or performed at all in certain embodiments. Accordingly, some implementations of the methods discussed herein may include more or fewer steps than those shown or described. Further, the techniques and mechanisms of the present invention will sometimes describe a connection, relationship, or communication between two or more entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection, unless otherwise noted.

The following list of example features corresponds to the attached figures and is provided for ease of reference, where like reference numerals designate corresponding features throughout the specification and figures:
5A Headset
5B Headset
5C Headset
10A First Earpiece
10B Second Earpiece
12A Compliant Connector
12B Compliant Connector
12C Compliant Connector
15A First Member
15B Second Member
16A First Set of Members (may be rigid or compliant)
16B Second Set of Members (may be rigid or compliant)
16C Third Set of Members
20A First Coupling
20B Second Coupling
22 Pre-deformation Shape
23 Elastically Deformed Shape
25 Headphone Expansion Directions
30 Helmet
33 Helmet Ear Flap
35 Restorative Force Imparted by Compliant Connector
40 Data/Power Lines
42 Communications Unit
44 Battery
45 Protective Sheath
50 Spring
55 Earpiece Pocket
60 Over-the-crown Installation
65 Over-the-skull-base Installation
105 Headset System
106 Earpiece/Speaker/Communication Unit Enclosure
107 Strap Organizer Piece
108 Strap Guide(s)
109 Cavity for Earpiece/Speaker/Communication Unit
110 Earpiece/Speaker/Communication Unit
111 Flexible Enclosure Overlay
112 Snap-fit or Friction-fit Connectors/Extrusions
115 Microphone Apertures
115A Microphone Windscreen
115B Microphone Windscreen Cage/Support
116 Tongue Insert for Y-type Strap
117 Snap-fit or Friction-fit Connections between Flexible Enclosure Overlay and Strap Organizer Piece
118 Keyhole Cutout
119 Front Notch in Tongue Protrusion
124A Cutouts for Flexible Enclosure Overlay Connectors
124B Flexible Enclosure Overlay Connectors/Extrusions
170 Earpiece/Speaker/Communication Unit Port
172 Display Screen for Earpiece/Speaker/Communication Unit
173 Microphone
175 User Interface (UI) Button on Earpiece/Speaker/Communication Unit
180 Headset Assembly
185 Fastener Insert Strap(s)
187 First Fastener Surface
188 Second Fastener Surface
189 Fastener Surface on the Back of the Strap Organizer Piece
190 Back Loop Created by Fastener Insert Straps
195 Y-type Helmet Strap
195A Upper Left Portion of Y-type Strap
195B Upper Right Portion of Y-type Strap
195C Lower Vertical Portion of Y-type Strap
199 Helmet Strap Buckle

As defined herein, a “compliant connector” is an elastically deformable structure (e.g., made of plastic, metal, or fiberglass) that bends or stretches under applied force and generates a restorative force to return to its pre-deformation shape. The restorative force secures the headset by biasing earpieces against helmet surfaces.

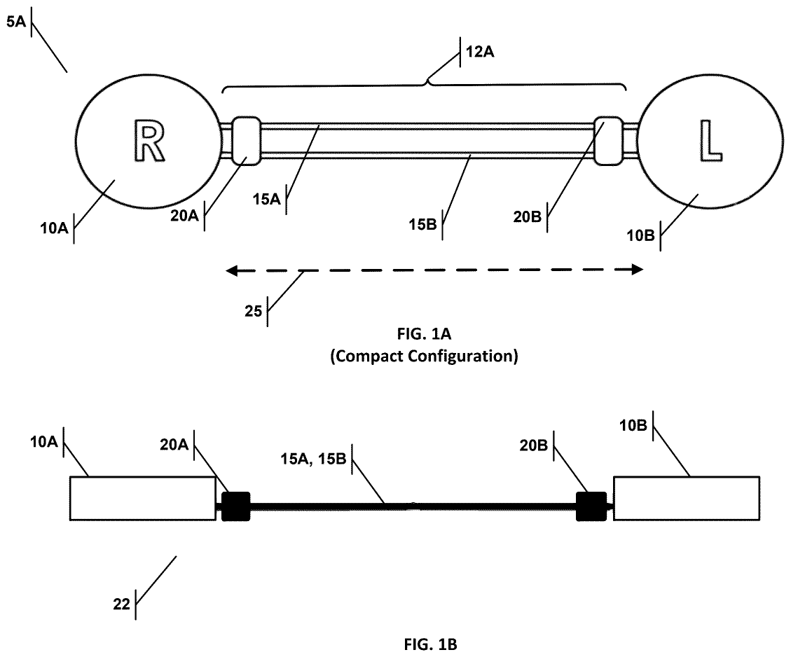

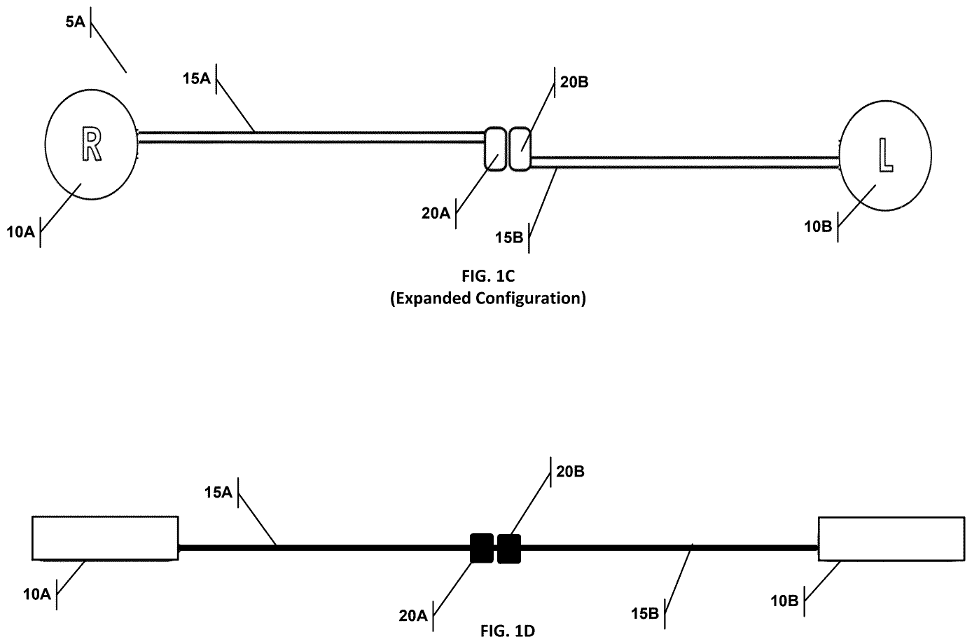

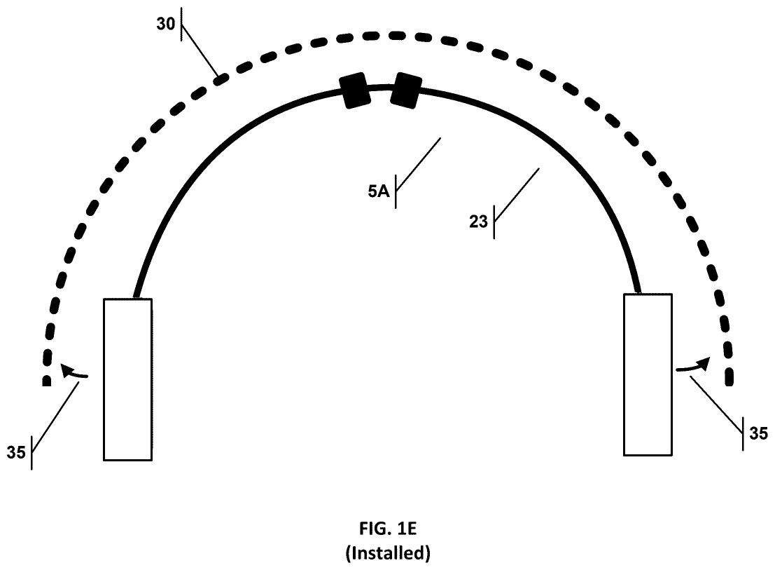

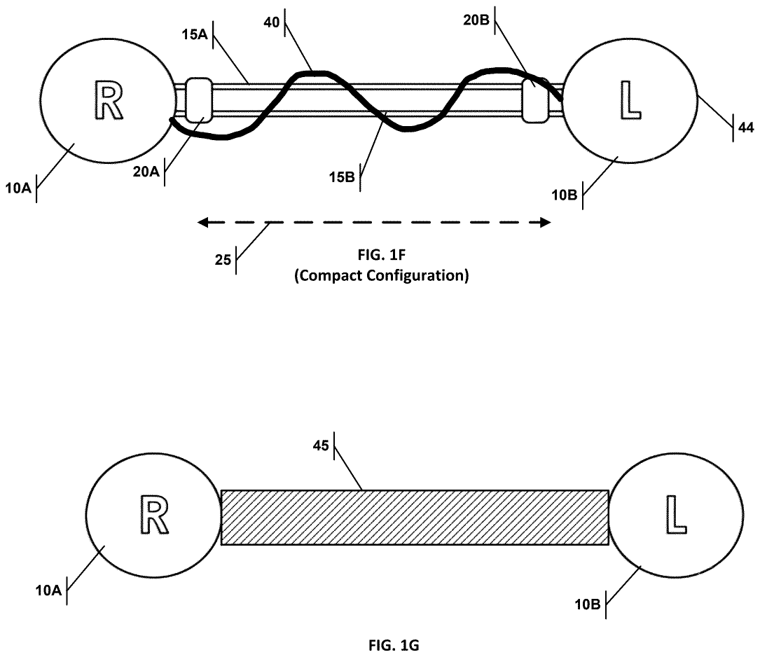

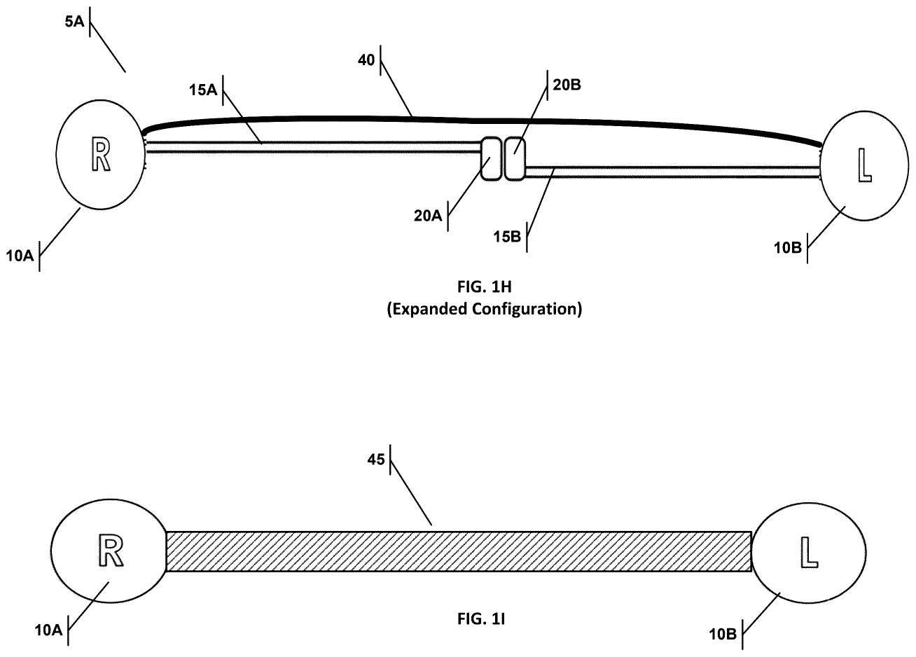

A first embodiment of the present invention is illustrated in the top view of FIG. 1A and in the side view of FIG. 1B. The headset 5A comprises a first earpiece 10A, a second earpiece 10B, and a compliant connector 12A. The compliant connector 12A itself comprises a first member 15A, a second member 15B, a first coupling 20A nearer the first earpiece 10A, and a second coupling 20B nearer the second earpiece 10B. The first member 15A connects to the first earpiece 10A at one end and to the second coupling 20B at its other end. The second member 15B connects to the second earpiece 10B at one end and to the first coupling 20A at its other end. The arrows 25 show the directions along which the headset 5A can expand. The compliant connector 12A, as depicted in FIGS. 1A-1B, is in its compact configuration, and its pre-deformation shape 22 is shown to be elongate and substantially linear.

The compliant connector of the headset, as exemplified in embodiment 5A (FIGS. 1A-1I), is constructed using advanced manufacturing techniques to ensure precision and functionality. The connector may be formed by injection molding plastic members, such as those comprising first member 15A and second member 15B, selected for their elasticity and durability, with a Young's modulus of 1-10 GPa. This process allows for the integration of sliding couplings 20A and 20B, designed with tolerances of ±0.5 mm to facilitate smooth telescopic movement between the compact configuration (FIG. 1A) and the expanded configuration (FIG. 1C). These tolerances ensure consistent deformation and restorative force generation, as depicted in the curved shape 23 of FIG. 1E, while accommodating variations in helmet interior dimensions. The molded design, achievable with standard injection molding equipment, supports reproducible assembly and enhances the headset's adaptability across diverse applications.

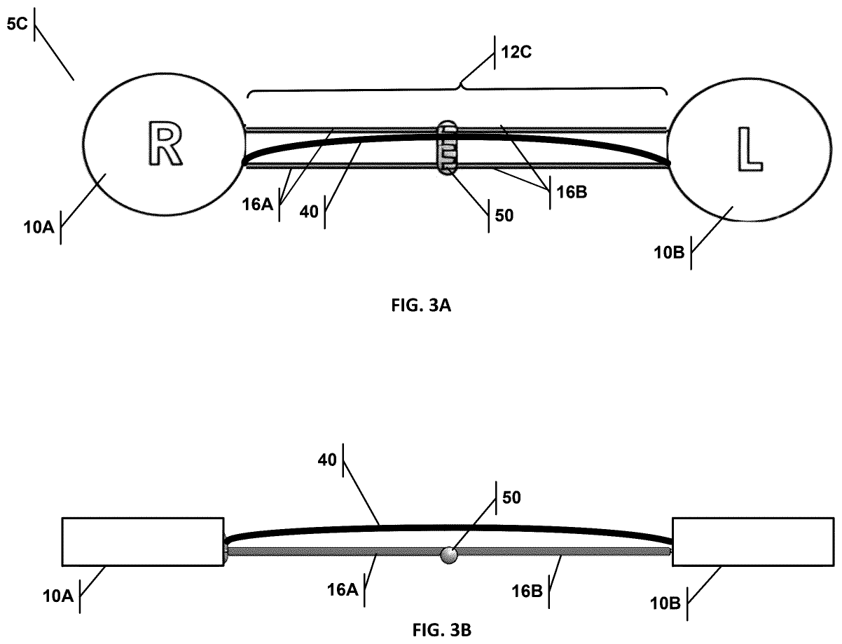

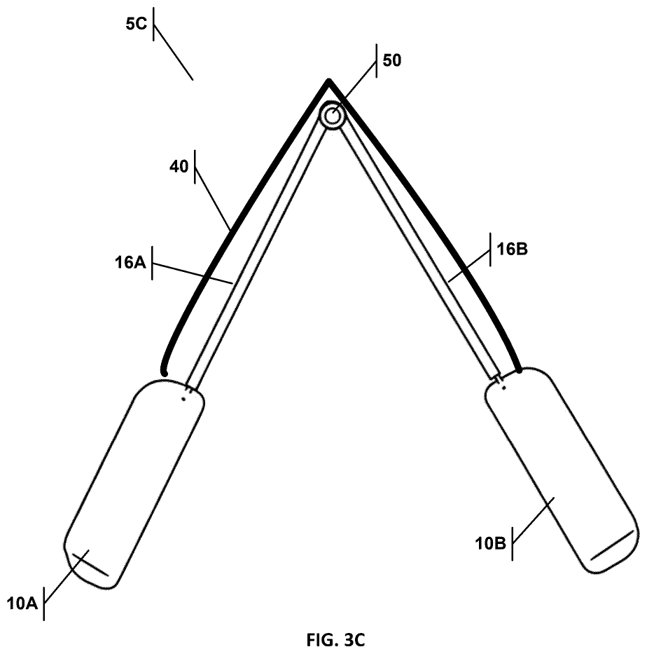

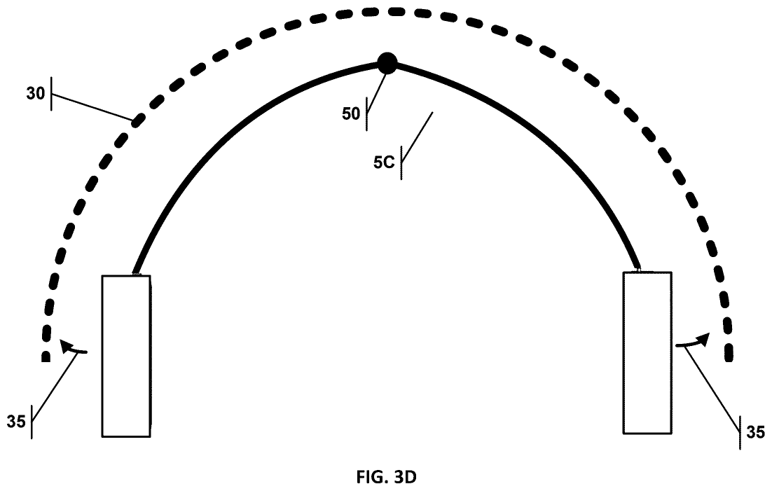

The compliant connector of the headset, as exemplified in embodiments 5A, 5B, and 5C, is engineered to exhibit specific mechanical properties that ensure reliable performance within a helmet environment. The connector's material, selected from plastic, metal, or fiberglass, possesses a Young's modulus ranging from 1-10 GPa, enabling it to elastically deform under an applied force of 2-5 N while maintaining structural integrity. This deformation, as illustrated in the curved shape 23 of FIG. 1E, generates a restorative force of 1-10 N that biases the first earpiece 10A and second earpiece 10B against the helmet's interior walls, securing the headset in a stable position. The restorative force is calibrated through material selection and design, such as the telescopic sliding connections of connector 12A (FIGS. 1F, 1H) or the spring 50 of connector 12C (FIG. 3D), ensuring consistent performance across helmet sizes and configurations. These properties facilitate easy installation and removal while preventing dislodgement during use.

In the next drawings of FIGS. 1C-1D, the headset 5A is shown in a maximally expanded configuration. From the compact configuration to the expanded configuration, the couplings 20A, 20B move toward each other, and FIG. 1C shows them as touching. FIG. 1C shows the top view, while FIG. 1D shows the side view.

When the headset 5A is installed into a helmet 30, as shown in FIG. 1E, then the compliant connector 12A (comprising the first member 15A, first coupling 20A, second coupling 20B, and second member 15B) bends or deforms such that its elastically deformed shape 23 inside the helmet 30 has a substantial curve. The arrows 35 indicate the direction of the restorative force imparted by the compliant connector 12A when it is installed in the interior of the helmet 30. In this position, the compliant connector is elastically deformed 23 and produces a restorative force 35 that pushes the first and second earpieces 10A, 10B against the interior wall of the helmet 30. The restorative force 35 maintains the position of the headset 5A within the interior of the helmet 30, but when the headset 5A is removed from the interior of the helmet 30, the compliant connector 12A returns to a pre-deformation shape 22.

The headset 5A may further comprise a communications unit 42 and a battery 44, and this is illustrated in the non-limiting example of FIG. 1F, which shows the communications unit 42 contained within the first earpiece 10A and the battery 44 contained within the second earpiece 10B. The placement of these elements may be reversed so that, for example, the battery 44 is contained in the first earpiece 10A, and the communications unit 42 is contained in the second earpiece 10B, in other implementations. The communications unit 42 can be wireless. However, the headset 5A may further comprise a data and/or power line 40 connecting the first earpiece 10A and the second earpiece 10B, as is illustrated in FIG. 1F.

FIG. 1F presents the compact configuration, and FIG. 1H presents the expanded configuration. In both drawings, the compliant connector 12A comprises a first member 15A extending from the first earpiece 10A, wherein the first member 15A is connected to a first coupling 20A and a second coupling, wherein the connection of the first member 15A to the first coupling 20A and/or the second coupling 20B is a sliding connection. Likewise, the compliant connector 12A comprises a second member 15B extending from the second earpiece 10B, wherein the second member 15B is connected to the first coupling 20A and to the second coupling 20B, wherein the connection of the second member 15B to the first coupling 20A and/or the second coupling 20B is a sliding connection. Explained another way, both FIG. 1F and FIG. 1H both illustrate a compliant member 12A that comprises 1) a first member 15A extending from the first earpiece 10A, wherein the first member 15A is connected to a first coupling 20A and slides through a second coupling 20B; and 2) a second member 15B extending from the second earpiece 10B, wherein the second member 15B is connected to the second coupling 20B and slides through the first coupling 20A.

FIG. 1G shows a protective sheath 45 that covers the compliant connector 12A while the compliant connector 12A is in its compact configuration. FIG. 1I shows the protective sheath 45 when the compliant connector 12A is in its expanded configuration. The compliant connector 12A of FIGS. 1A-1I is telescopic and can slide along the directions indicated by the arrows 25 in FIGS. 1A and 1F. The protective sheath 45 should therefore be telescopic as well to cover the compliant connector 12A in both its compact and expanded configurations.

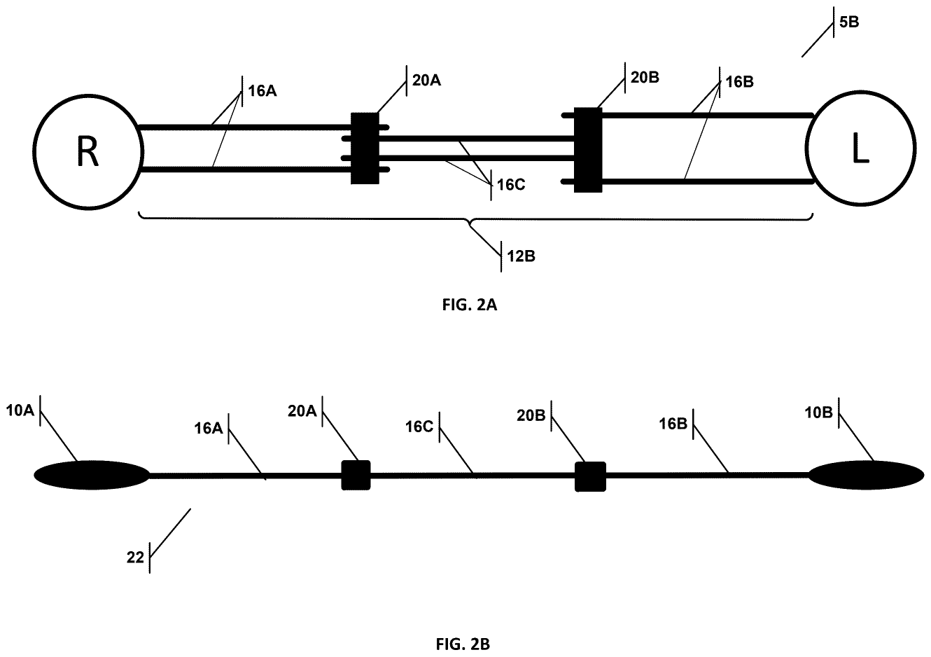

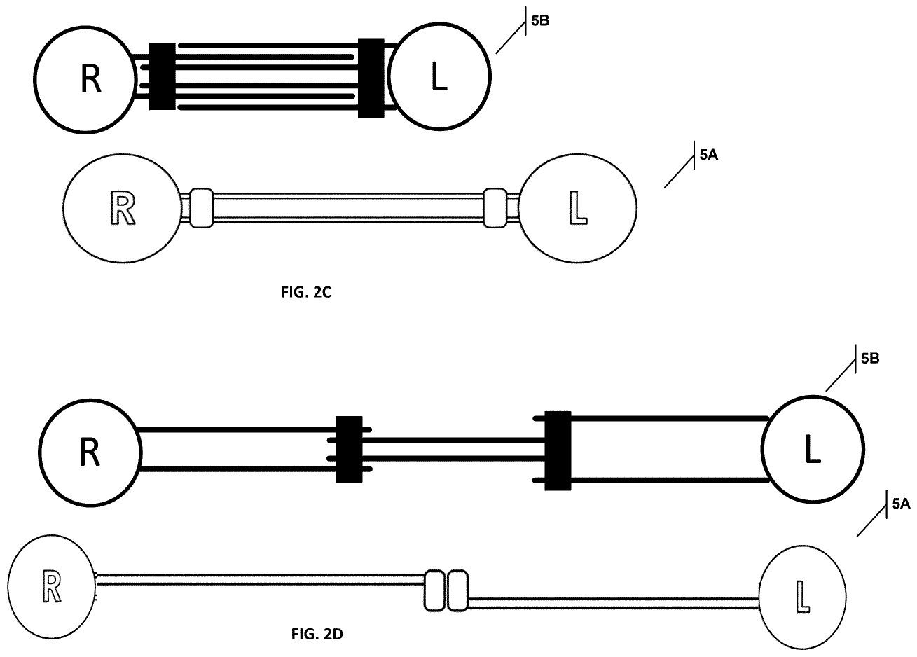

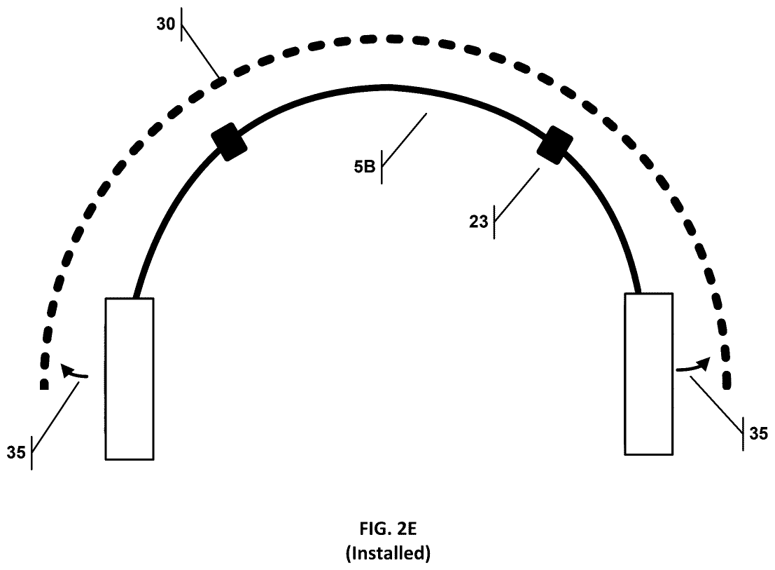

Turning now to FIG. 2A, a second embodiment of the headset 5B is now introduced. Note that the compliant connector 12B of headset 5B differs from the compliant connector 12A appearing in headset 5A. The compliant connector 12B of headset 5B comprises: 1) a first member or set of members 16A extending from the first earpiece 10A, wherein the first member or set of members 16A is connected to a first coupling 20A; 2) a second member or set of members 16B extending from the second earpiece 10B, wherein the second member or set of members 16B is connected to a second coupling 20B; and 3) a third member or set of members 16C connected to the first coupling 20A and to the second coupling 20B. FIG. 2B indicates that the pre-deformation (or compact configuration) shape 22 is elongate and is substantially linear. The advantage of having a third member or set of members can be seen in FIGS. 2C-2D, which show that the second embodiment headset 5B has a shorter length when compared to the first embodiment headset 5A in the compact configuration (FIG. 2C), yet stretches to the same length as 5A when expanded (FIG. 2D).

The installation of headset 5B, illustrated in FIG. 2E, is similar to that of headset 5A, with the headset 5B having a similarly elastically deformed shape 23 that is substantially a curve inside the helmet 30. There is also a restorative force 35 in headset 5B when installed in the interior of the helmet 30. With headset 5B, the first, second, and third members or sets of members can be compliant and all elastically deformable. Alternatively, only the middle part has to be compliant, so the headset 5B may also have the first and second members or sets of members being rigid, and the third member or set of members being compliant.

FIG. 3A illustrates a third embodiment 5C. This embodiment has a third type of compliant connector 12C, which comprises: 1) a spring 50, 2) a first member 15A extending from the spring 50, wherein the first member 15A is connected to the first earpiece 10A; and 3) a second member 15B extending from the spring 50, wherein the second member 15B is connected to the second earpiece 10B. FIG. 3B shows the pre-deformation shape 22 of headset 5C, which is elongate and substantially linear.

FIG. 3C shows that, contrary to 5A and 5B, headset 5C can deform into a different shape. The data/power lines 40 are noticeably longer than the sum of the lengths of the first and second members 16A, 16B to prevent the data/power lines 40 from getting caught in the spring 50. Although headset 5C is capable of a more angular deformation if the earpieces 10A, 10B are brought together within enough force, once installed inside a helmet 30, headset 5C behaves substantially like the earlier-described headsets 5A and 5B. Seen in FIG. 3D, headset 5C also deforms to substantially a curve shape inside a helmet 30, and also produces a restorative force 35 that pushes the first and second earpieces 10A, 10B against the interior wall of the helmet 30. When the headset 5C is uninstalled from the interior of the helmet 30, the compliant connector 12C will return to a pre-deformation shape 22, as seen in FIG. 3B.

In any of the embodiments 5A, 5B, 5C and configurations, the compliant connector 12A, 12B, 12C may be made of plastic, metal or fiberglass. The first earpiece 10A may comprise a first speaker, and the second earpiece 10B may comprise a second speaker. The two speakers, in any of the embodiments described herein, may work together to play the same sound, i.e. stereo speakers, or may operate independently to play sounds from different sources. In any of the examples, the headset 5A, 5B, 5C may further comprise a microphone in addition to the speakers.

In any of the embodiments 5A, 5B, 5C and their associated configurations, the first and second earpieces 10A, 10B can be detached from the compliant connector 12A, 12B, 12C. This property gives at least three advantages. Firstly, detaching the earpieces 10A, 10B, makes installation easier. Secondly, in a situation where awareness of the environment is desired, it is an option to only have one earpiece playing sounds, while the user's other ear not having an earpiece over it can be used to pay attention to the surroundings. Finally, the modular nature of the present invention makes for flexibility in the use of the device, such as fitting differently sized helmets with the same earpieces, switching out earpieces to replace depleted charge earpieces for fully charged earpieces, or for portability of the earpieces 10A, 10B. The headset components can be more easily stored while disassembled in a jacket pocket or when stored elsewhere when the headset 5A, 5B, 5C are not needed.

The first and second earpieces 10A, 10B can be detached from the compliant connector 12A, 12B, 12C and can be replaced by a connector that pushes the earpieces against the user's ears. Alternatively, the earpieces can be slipped into dedicated pockets in the helmet next to the user's ears. For example, it may be possible to secure headsets inside pockets that can be placed close to the wearer's ears with a hook-and-loop fastener. In case the helmet 30 itself includes a special sleeve at the back, the connecting wire can be put in that special sleeve, and that sleeve may comprise a closure method such as a zipper. If the headset 5A, 5B, 5C is wireless, the earpieces 10A, 10B can be placed as described above, without requiring any wired connection between the earpieces.

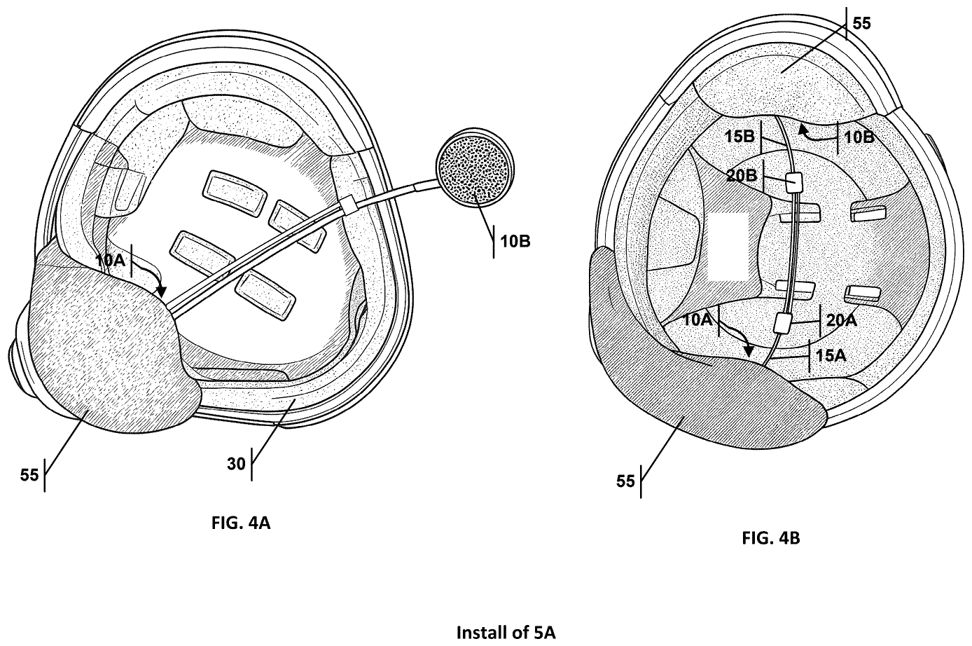

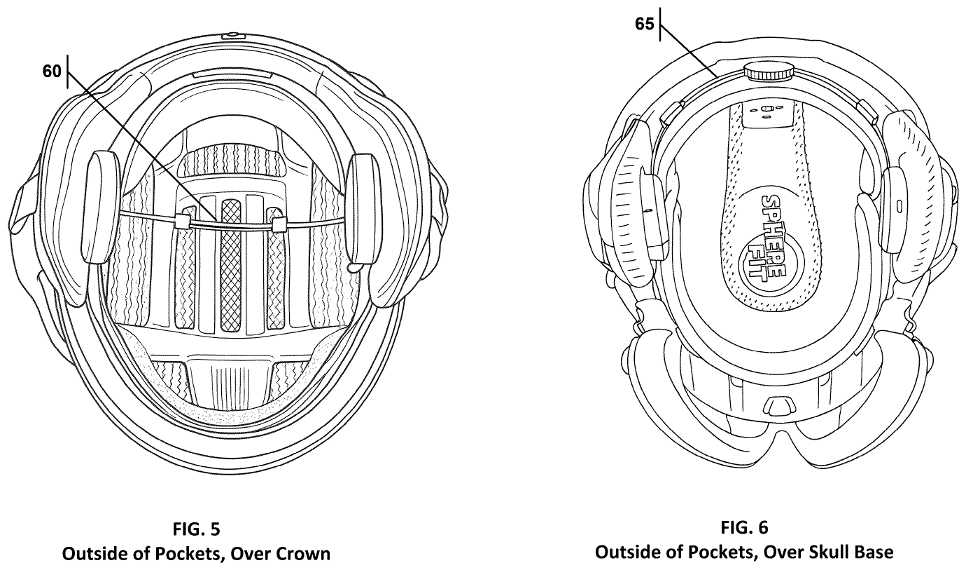

FIG. 4A shows one of the final steps during installation, where the first earpiece 10A is already positioned within an earpiece pocket 55 of the helmet 30. The second earpiece 10B is outside of the helmet and not inside an earpiece pocket.

FIG. 4B shows the positions and the deformed shape 23 of the headset 5A after the final stage of installation. Both the first and second earpieces 10A, 10B are now positioned inside the earpiece pockets 55. The first member 15A extends from the first earpiece 10A, wherein the first member 15A is connected to a first coupling 20A and slides through a second coupling 20B. A second member 15B extends from the second earpieces 10B, wherein the second member 15B is connected to the second coupling and slides through the first coupling 20A. These compliant members 15A, 15B, 20A, 20B force the earpieces 10A, 10B against the helmet, stabilizing the position of the headset 5A inside the helmet 30.

FIGS. 5 and 6 show that the compliant connector 12A may be placed in different configurations inside a helmet 30. In FIG. 5, the compliant connector 12A is shown in an over-the-crown installation 60, where the compliant connector 12A is positioned near the crown of the wearer's head. In FIG. 6, the compliant connector 12A is shown in an over-the-skull-base installation 65. Both installation methods make use of the restorative force to push the earpieces against the interior wall of the helmet 30. In both FIGS. 5 and 6, the earpieces are shown outside of the earpiece pockets to demonstrate the positions and directions of the compliant members more clearly.

The next embodiment of the present invention is one where the position of the headset is stabilized by using fastener straps alongside the helmet's straps to secure the positioning of an enclosure 106 for an earpiece or communication unit 110. “Earpiece,” “speaker,” and “communication unit” may refer to the same component unless context dictates otherwise. The structural components primarily comprise an earpiece/speaker/communication unit enclosure 106 attached to a strap organizer piece 107. These two components may be attached by any one of a plurality of methods, such as snap-fit, glue, and welding, just to name a few non-limiting options. Both pieces have an overlapping keyhole cutout 118 that allow sound from the speaker of the earpiece or communication unit 110 to better enter the user's ear without obstruction.

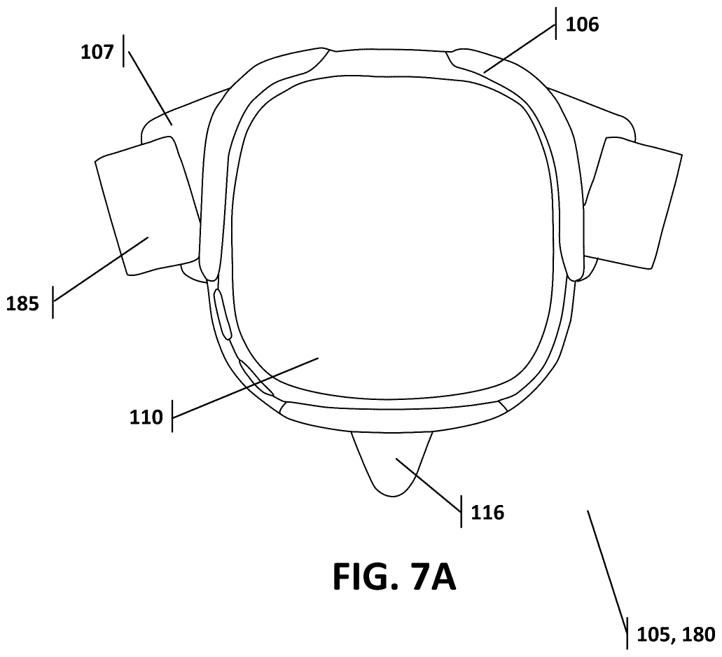

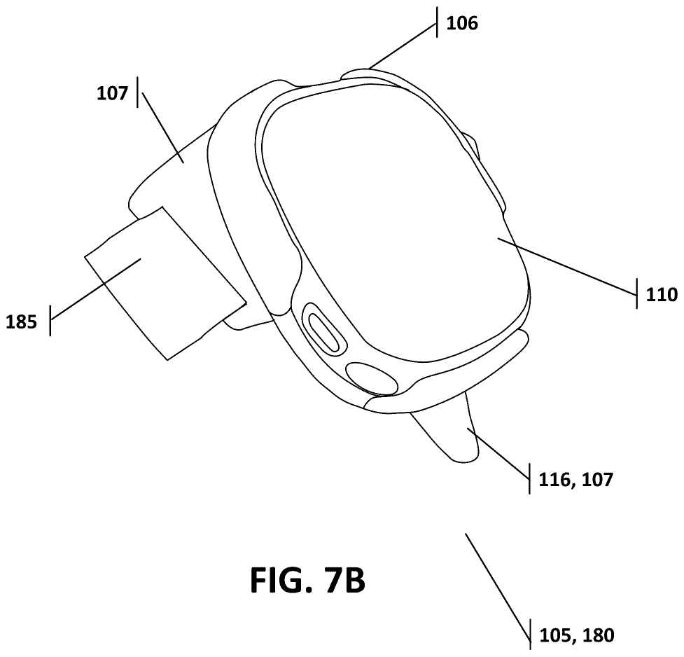

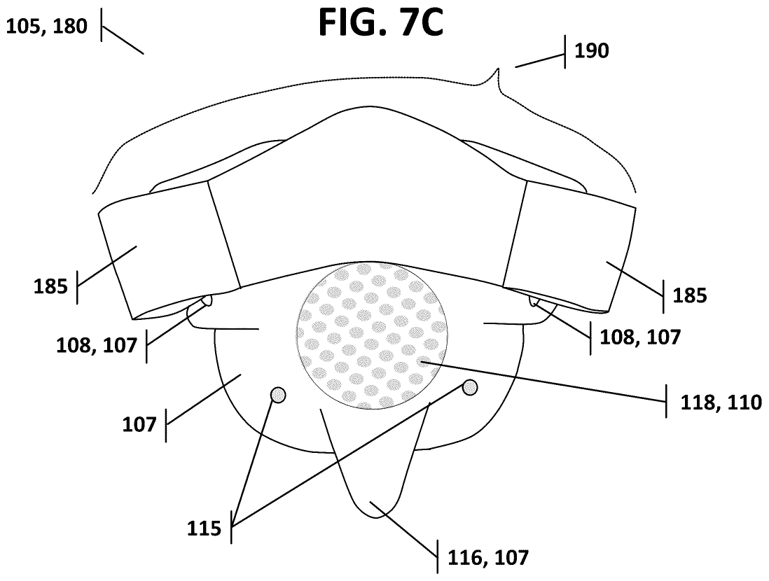

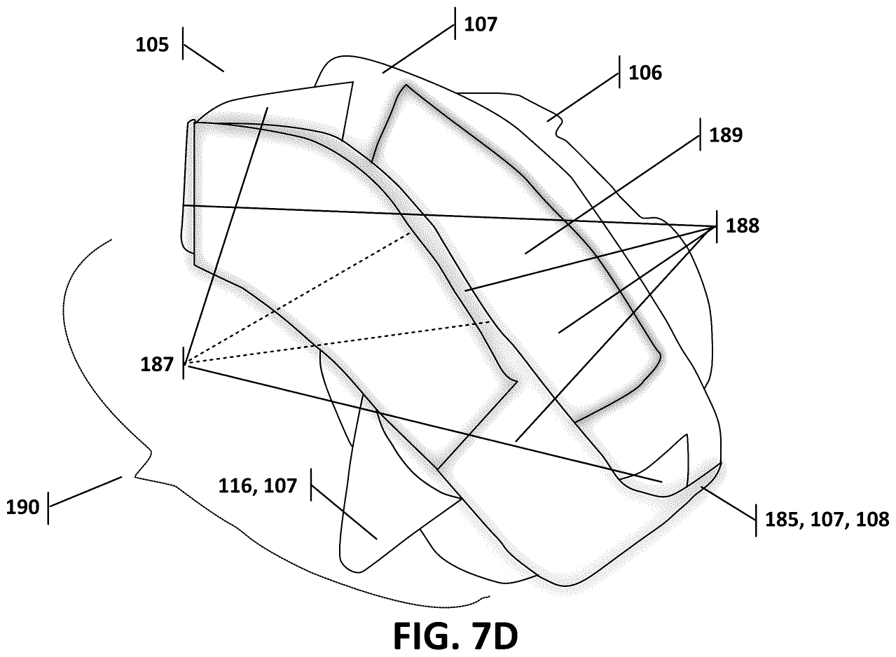

Turning now to FIGS. 7A-7B which show a headset system 105 fully assembled (but not yet installed on a safety helmet), with the communication unit or earpiece 110 fitting snugly and securely inside an enclosure 106. The enclosure 106 is also attached to a flat strap organizer piece 107. The strap organizer piece 107 may be attached to the enclosure 106 via permanent or non-permanent means. The two pieces may be joined by glue, welding, injection molding, snap fit, friction fit, a hook-and-loop fastener, or one or more screws. The strap organizer piece 107 has a tongue protrusion 116 and strap insert guides 108 (not visible because they are covered by the fastener insert straps 185). FIG. 7A offers a front view, and FIG. 7B offers a side perspective view of the headset system 105.

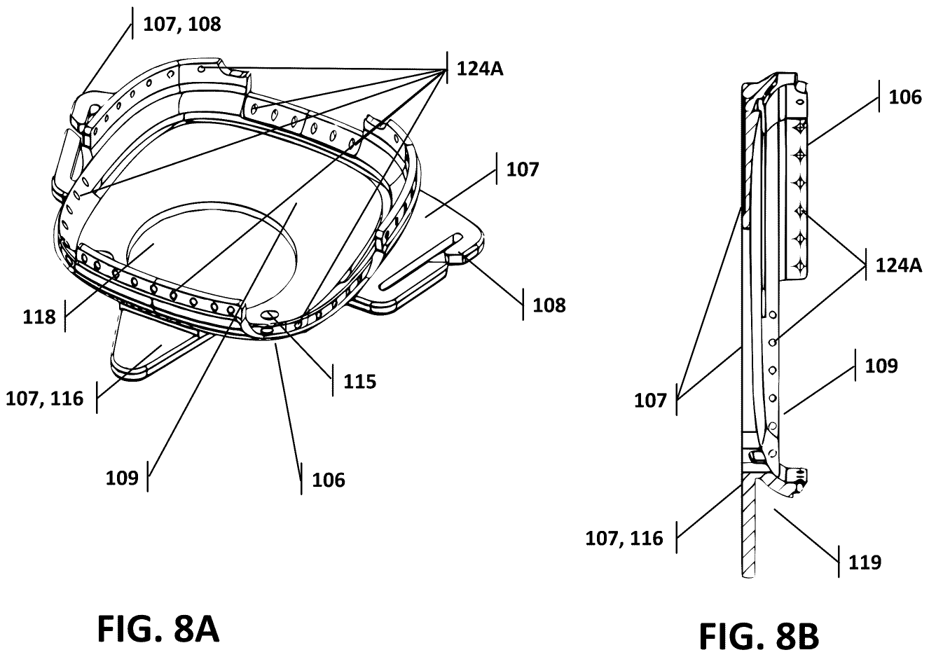

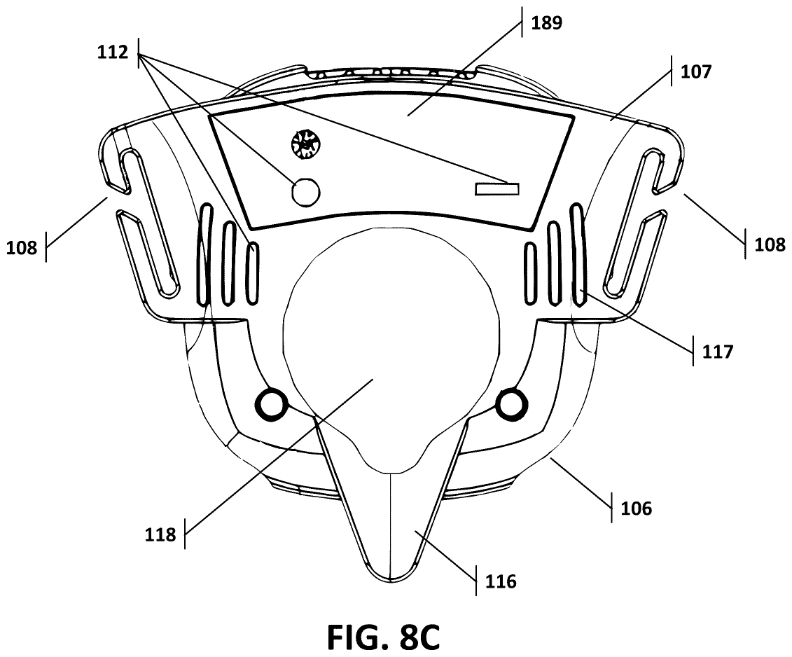

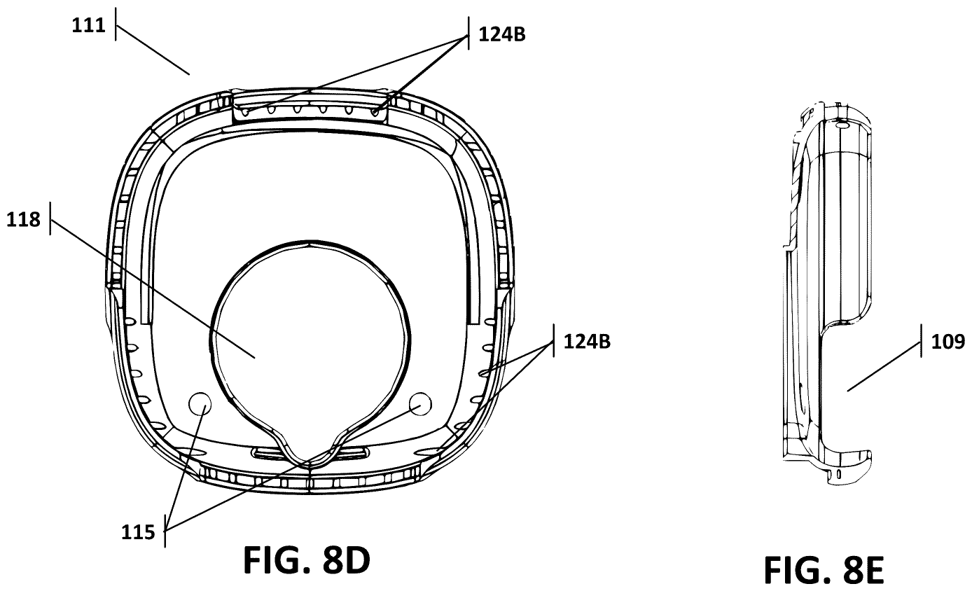

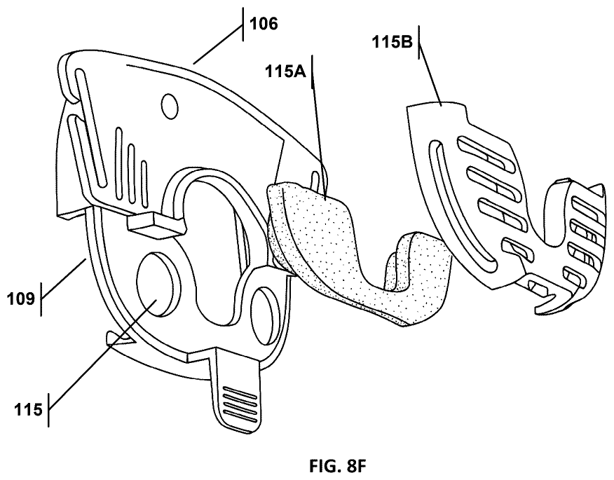

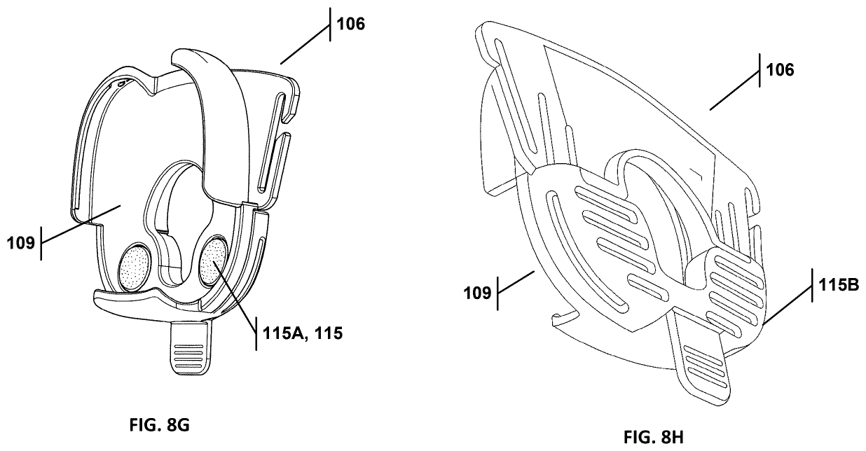

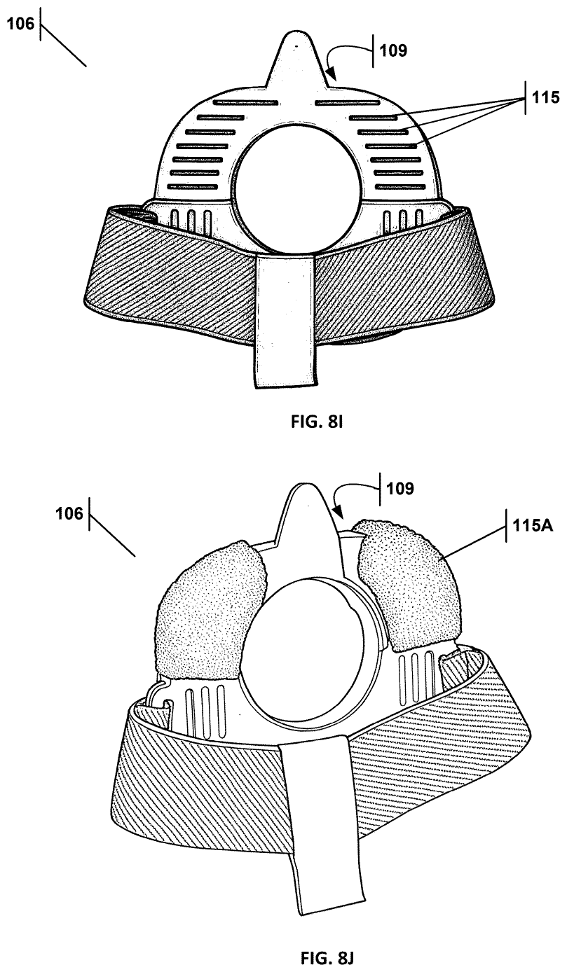

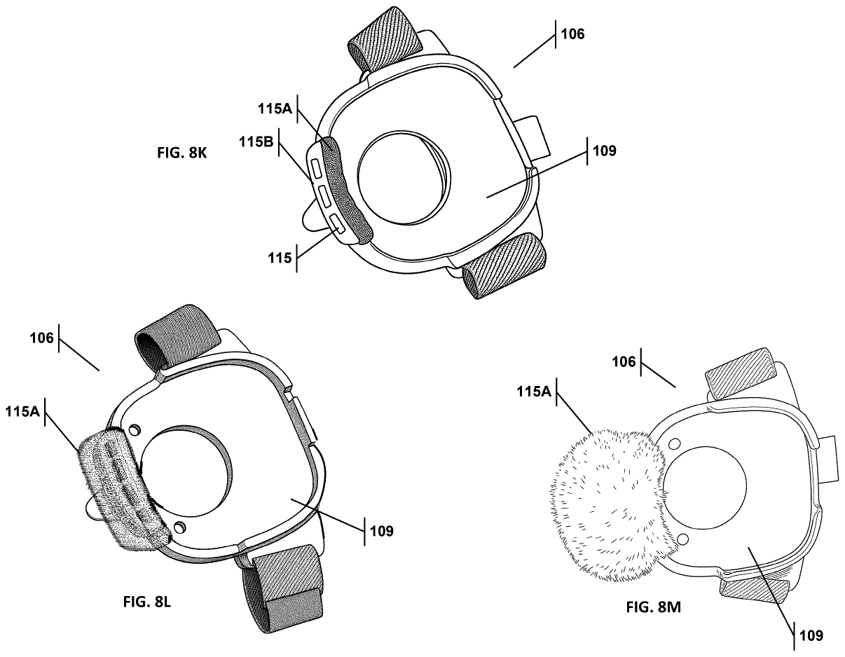

FIG. 7C shows the back side of the headset system 105. The fastener straps 185 loop through the strap insert guides 108 (please refer to FIGS. 8A-E for a better view). There is a keyhole cutout 118 that allows sound to enter the user's ear with minimal obstruction and a microphone aperture 115 that allow sound to pass to the microphone on the communication unit 110. The fastener straps 185 can be arranged in a back loop 190 into which helmet straps can be fitted when the headset system 105 is installed.

In the back perspective view of FIG. 7D, more details concerning the back loop 190 formed by the fastener straps 185 are visible. The one or more fastener straps 185 feature two fastener surfaces 187, 188 that can securely mate with one another. As a convenient but non-limiting example, the drawing shows the first fastener surface 187 as a male Hook-and-loop fastener surface and the second fastener surface 188 as a female Hook-and-loop fastener surface. The first fastener surface 187 mates securely with the second fastener surface 188 such that the two pieces of fastener straps 185 form into a back loop 190 through which helmet straps could pass through and secure the headset system 105. The dotted lines for element 187 indicate that the first fastener surface or the male Hook-and-loop fastener surface 187 is on the backside of where the dotted lines point. There is also an option to have a fastener surface 189 secured to the back of the strap organizer piece 107 that will securely mate with the first fastener surface 187. The strap organizer piece fastener surface 189 may be attached by glue, with screws or myriad other means. In FIG. 7D, this extra fastener surface 189 mates securely with the male Hook-and-loop fastener surface 187, and confers the advantage of enabling the one back loop formed by the fastener straps 185 to be turned into two, one on either side of the strap organizer piece 107, if the center part of the back loop 190 is pressed into the fastener surface 189. In theory, a plurality of fastener straps 185 could be used, and a plurality of extra fastener surfaces could be used, resulting in a plurality of loops for helmet straps for the headset system 105 to secure to, without departing from the spirit and scope of the present invention.

Next, the various components of the headset system 105 will be shown in schematic details to gain a better understanding of underlying structure and advantages. The enclosure 106 also features a cavity 109, into which an earpiece or communication 110 can be housed and securely mated with the enclosure 106. This cavity 109 is better viewed in the side view of FIG. 8B. Also visible in FIG. 8A are a plurality of cutouts 124A for the enclosure 106 to securely mate with a flexible enclosure overlay 111, which will be better explained in association with FIGS. 8D-8E. Depending on the material used to construct the enclosure 106, The cutouts 124A and the flexible enclosure overlay 111 may be optional and not required.

As seen in the top perspective view of FIG. 8A and the side view of FIG. 8B, the strap organizer piece 107 features a pair of strap insert guides 108 on either side of the enclosure 106, more proximate to the top edge. Against the bottom edge of the enclosure 106 on the strap organizer piece 107 is a tongue protrusion 116, which is intended for use with a Y-type helmet strap. FIG. 8C presents a back view or rear view of the strap organizer piece 107. Note the various snap-fit connectors 112. The keyhole cutout 118 and microphone apertures 115 present in the enclosure component 106 overlaps with corresponding cutouts in the strap organizer piece 107, such that this keyhole cutout 118 may assist in the user more easily hearing the sound playing from the speaker of the earpiece or communication unit 110 when the earpiece or communication unit 110 is securely fitted or mated into the enclosure 106. Depending on the design of the earpiece or communication unit 110 that fits into the enclosure cavity 109, the keyhole cutout may allow for a clip on the earpiece or communication unit 110 to clip onto the rear surface of the tongue protrusion 116, or the earpiece or communication unit 110 may have a protrusion in the speaker portion that extends through the keyhole cutout 118 towards the user's ear when the earpiece or communication unit 110 securely mates with the enclosure 106. The purpose of the tongue protrusion 116 is for an additional point of contact between the headset assembly and the helmet straps; either the tip of the tongue protrusion 116 may slip inside a knot or a junction in a Y-type strap, or the junction of the Y-type strap may be slipped into the notch 119 in the front of the tongue protrusion, more easily seen in the side view of FIG. 8B.

In FIG. 8C, the area above the keyhole cutout 118 on the back of the strap organizer piece 107 can optionally feature an addition fastener surface 189, which can mate with either the first fastener surface or second fastener surface. Another option—not a requirement—are snap-fit or friction-fit connections 117 between the flexible enclosure overlay 111 and the strap organizer piece 107, which may be shaped differently than the snap-fit connectors and cutouts 112 between the enclosure 106 and the flexible enclosure overlay 111.

Turning now to FIGS. 8D-8E, the flexible enclosure overlay 111 should be discussed. To secure a headset or an earpiece with a snap-fit or friction-fit connection, it is desirable to have a rigid underlying structure as well as a flexible surface with plenty of friction. Thus, using a flexible enclosure overlay 111 that is formed of a soft grip material such as thermoplastic elastomers (TPE) is preferred to the alternative, which forms the enclosure component 106 out of entirely flexible materials or entirely rigid materials. The flexible enclosure overlay 111 can be formed with a plurality of precisely placed snap-fit protrusions or connectors 124B, which can be fitted into the cutouts 124A of the enclosure component 106. Note that the microphone apertures 115, the keyhole cutout 118, and the cavity 109 overlap those on the enclosure component 106.

FIG. 8F illustrates a highly effective three-component wind-noise mitigation assembly that is seamlessly integrated with the microphone enclosure 106. A windscreen 115A, denoted as element 115A, is fabricated from a highly porous, acoustically transparent material capable of disrupting and dissipating turbulent airflow. Suitable materials include, without limitation, open-cell polyurethane foam having 60-100 pores per inch, reticulated foam, fine-pile synthetic fur, woven or non-woven acoustic mesh, or multi-layer composites thereof. The windscreen 115A is mechanically captured and securely retained by a rigid or semi-rigid slotted cage or support structure 115B. The cage 115B features a plurality of through-slots or perforations that are generously sized and precisely aligned with the underlying microphone apertures 115, thereby ensuring negligible attenuation of desired speech frequencies while providing robust mechanical protection to the relatively delicate windscreen material.

The cage/support 115B is designed to positively attach to the exterior surface of the enclosure 106—directly opposite the internal cavity 109 that contains the microphone(s)—via snap-fit detents, barbed posts, adhesive bonding, ultrasonic welding, heat staking, or a combination thereof. This arrangement guarantees that the windscreen 115A remains in intimate contact with the enclosure surface across the entire array of microphone apertures 115 under all operating conditions, including high vibration, extreme temperatures, and prolonged exposure to moisture.

FIGS. 8G and 8H present isometric and orthographic views of the completely assembled three-piece module (enclosure 106+windscreen 115A+cage/support 115B), clearly demonstrating the compact profile, unobstructed mounting features, and aerodynamic continuity that are essential for helmet-mounted applications.

The primary function of windscreen 115A is to prevent direct impingement of high-velocity, turbulent airflow (generated by forward motion of the rider, helmet buffeting, or exhaled breath) onto the microphone diaphragms. By forcing the airflow to navigate the tortuous pathways within the porous matrix, kinetic energy is converted to heat via viscous and inertial losses, dramatically reducing pressure fluctuations at the microphone ports. Empirical testing has shown reductions exceeding 20-30 dB in wind-induced noise below 500 Hz, with minimal insertion loss (<2 dB) above 1 kHz-preserving the critical consonant energy necessary for excellent speech intelligibility in helmet intercoms, Bluetooth® headsets, action-camera audio tracks, and two-way radio systems.

An alternate and equally effective approach is disclosed in FIGS. 8I-8M, wherein the microphone apertures 115 are configured as a series of elongated, parallel slots rather than discrete circular holes. The slotted geometry provides a larger total open area for improved acoustic coupling while simultaneously acting as a first-stage diffuser that begins to break up coherent turbulent structures before they encounter the windscreen.

In the embodiment of FIGS. 8I and 8J, the windscreen 115A is applied to the exterior surface of the enclosure 106, covering all slots. Retention may be achieved via the external cage/support 115B described previously, by adhesive, by stretch-fit, or by entrapment within a shallow recessed pocket molded into the enclosure.

FIGS. 8K-8M illustrate additional embodiments in which the windscreen 115A is relocated to the interior surface of the enclosure 106, facing the internal cavity 109. Internal placement offers several advantages: (i) the windscreen is shielded from UV degradation, abrasion, and accidental removal; (ii) the exterior surface remains smooth for improved aesthetics and easier cleaning; and (iii) the windscreen is less prone to saturation in heavy rain because it is protected by the enclosure wall.

To ensure the internally placed windscreen remains correctly positioned and does not sag or migrate under vibration or G-forces, a dedicated internal windscreen retainer/support 115B is provided (FIG. 8K). This retainer may take the form of a thin ribs, posts, a perforated plate, or a secondary snap-in frame that presses the windscreen 115A uniformly against the inner wall while preserving acoustic pathways to each slot.

To further enhance wind noise attenuation and ensure optimal microphone performance in outdoor or high-wind environments, the earpiece or communication unit 110 may incorporate one or more additional active and digital mitigation techniques, either individually or in combination with the physical windscreens 115A. These techniques include automatic gain control (AGC) that dynamically adjusts microphone sensitivity in real time to prevent clipping or overload from sudden gusts while preserving speech intelligibility, dedicated wind noise reduction algorithms—such as multi-microphone beamforming, spectral subtraction, or machine-learning-based wind detection and suppression—implemented within the device's digital signal processor or audio processing firmware, and active noise control (ANC) specifically tuned for low-frequency wind buffeting that employs feedback or feed-forward microphones to generate anti-phase cancellation signals targeted at wind-induced pressure fluctuations. When used alongside the passive acoustic shielding provided by the windscreen 115A and its associated support structure 115B, these complementary software-and hardware-based features deliver significantly improved voice clarity and substantially reduced wind noise across a wide range of environmental conditions.

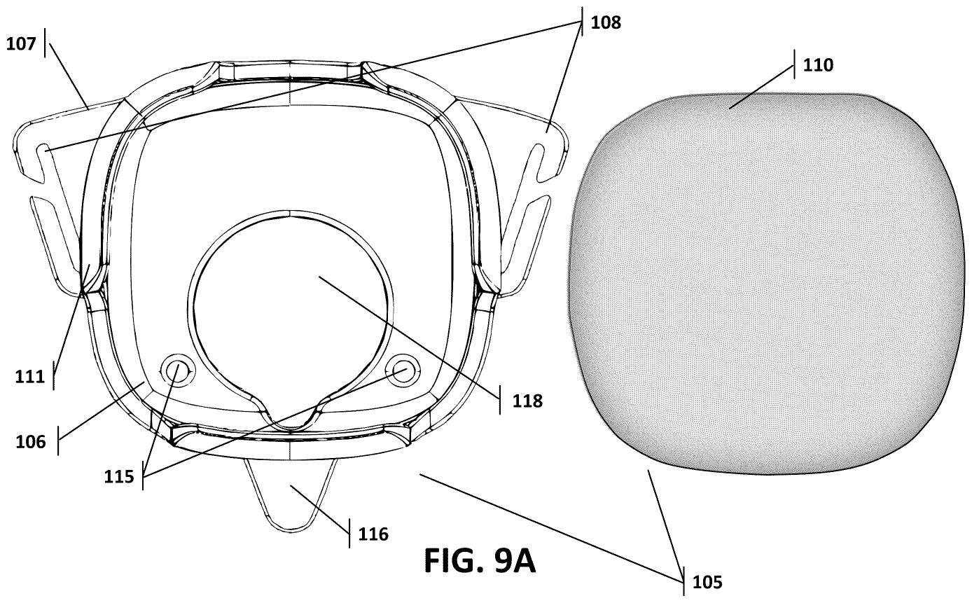

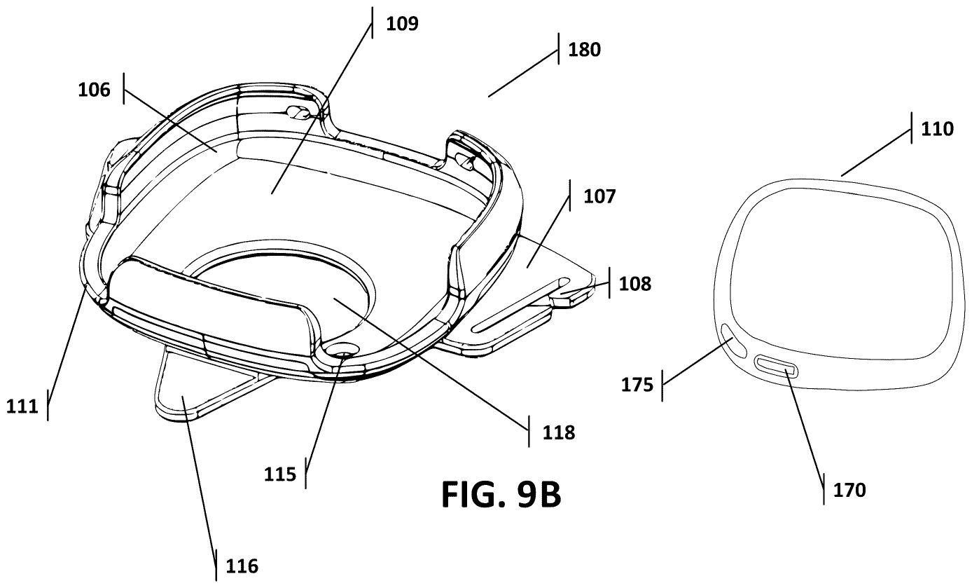

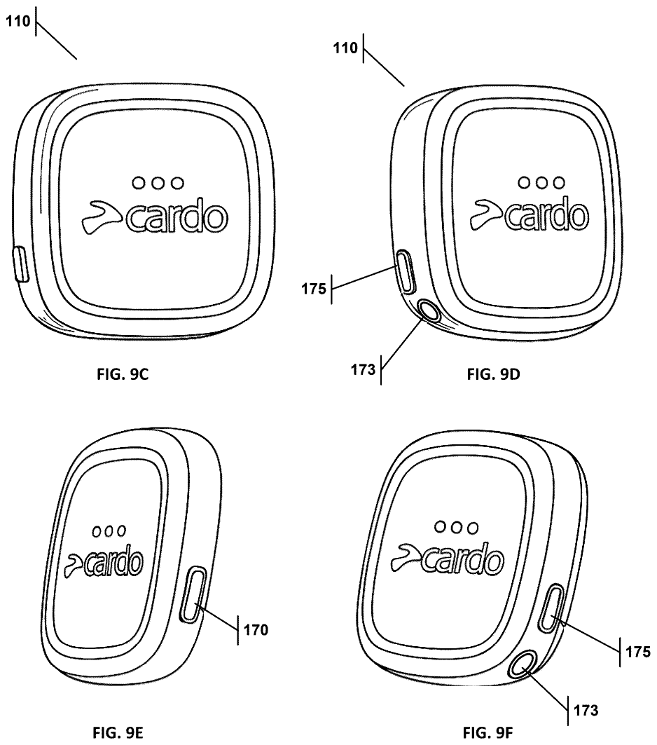

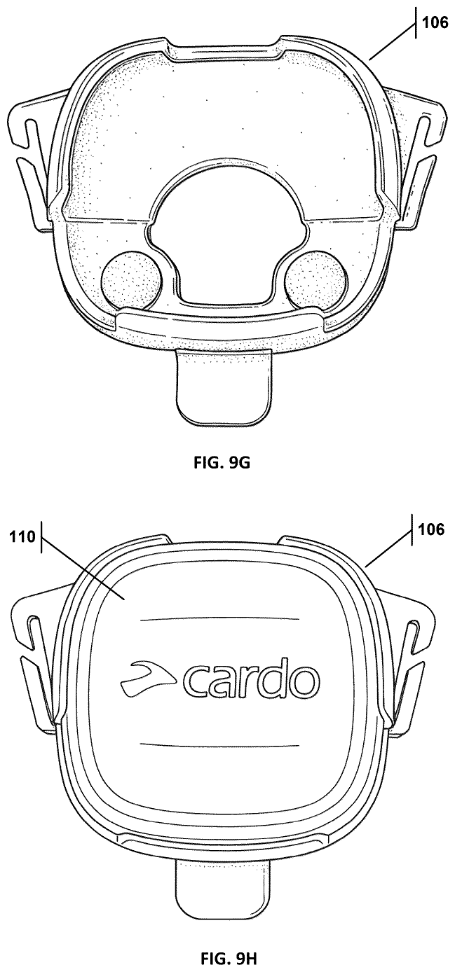

FIG. 9A provides a front view of the various pieces previously described that form part of the headset assembly 180 in a schematic format. The dimensions of the earpiece or communication unit 110 are slightly smaller than that of the flexible enclosure overlay 111 so that the earpiece or communication unit 110 can fit snugly inside the enclosure 106 with the flexible enclosure overlay 111. FIG. 9B provides a top perspective view of the headset assembly 180 and a top perspective view of the earpiece or communication unit 110. Also illustrated in FIG. 9B are a port 170 and a user interface button 175. The earpiece or communication unit 110 is turned in such a way that both a port 170 and a user interface button 175 are visible. The port 170 may be used to supply data to the earpiece or communication unit 110 or to charge the battery 44 within the earpiece or communication unit 110. One or more user interface buttons 175 may be used for controls such as on/off switching, volume control, skip, scan, mute/unmute, answer call, and other such functions. The earpiece or communication unit 110 may also comprise a screen 172, for displaying indicators such as battery status, Bluetooth state, mesh network communications state, pairing state, mute state, etc. The screen 172 may optionally be a touchscreen for more interactivity, and due to the convenient snap-fit connection, a user may wear and use the earpiece or communication unit 110 inside the enclosure, while conveniently taking it out when interactions are desired or needed. FIGS. 9C-9F illustrate a different configuration for the earpiece or communication unit 110, and show the microphone 173 on the earpiece or communication unit 110. FIGS. 9C-9E illustrate the earpiece or communication unit 110 for the left ear, and FIG. 9F for the right ear.

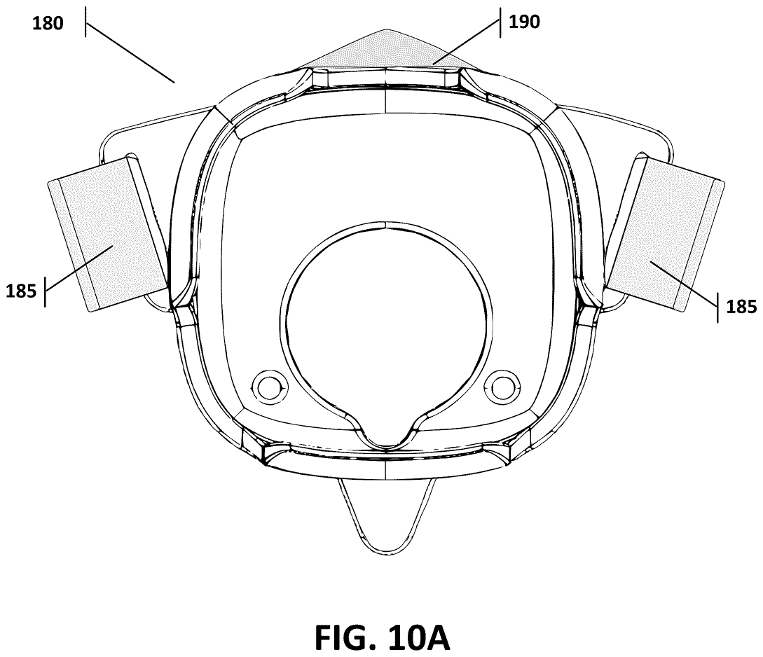

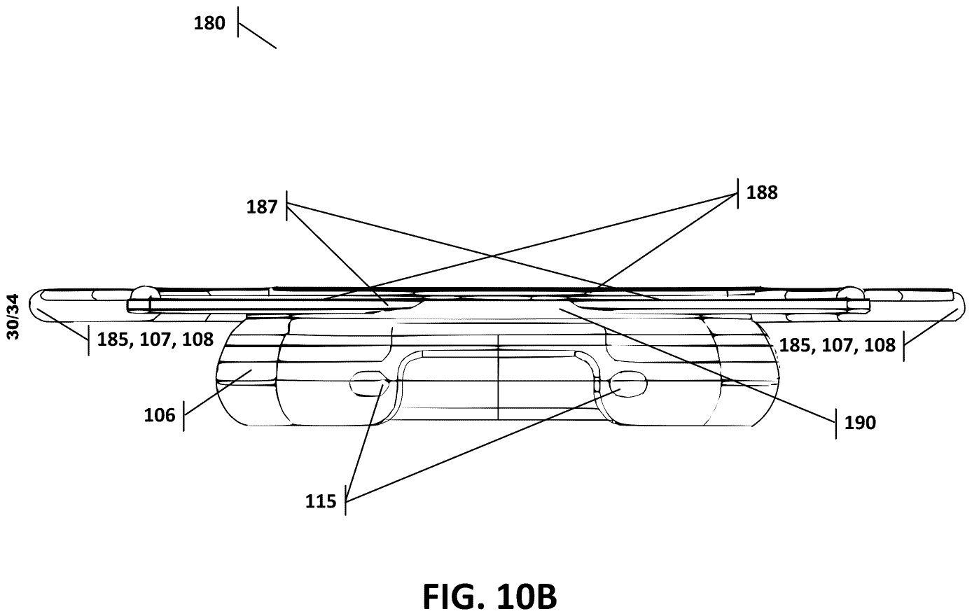

FIGS. 10A-10B incorporate the addition of fastener straps into the system. On the strap organization piece 107, one or more fastener insert straps can be slotted into the strap insert guides 108 and secured. The fastener straps 185 each has a first fastener surface 187 and a second fastener surface 188, and the two surfaces 187, 188 can attach to or securely mate with one another. As a non-limiting example, the first fastener surface 187 may be a male Hook-and-loop fastener surface, and the second fastener surface 188 may be a female Hook-and-loop fastener surface. One side of a fastener strap 185 may comprise the male Hook-and-loop fastener surface material, and the other side may comprise the female Hook-and-loop fastener surface material. When a fastener strap 185 is looped around a strap insert guide, it may fasten or mate with its other side. This allows for flexibility in practical use, as Hook-and-loop fastener attachments are reusable and strong and can be adjusted for more precise positioning. When one or more fastener insert straps 185 are overlapped behind the enclosure 106, they can form into a back loop 190, through which the helmet strap 195 can be inserted into the loop 190 (behind the enclosure 106) and secured with the fastener insert straps 185 to start installing the headset assembly 180. A hook-and-loop fastener is preferred due to the reasons cited above, but there are several known variations of fastening styles possible that do not depart from the spirit and scope of the present invention, if used, such as hook and loop fasteners, buttons and buttonholes, snaps, and magnets, to name but a few.

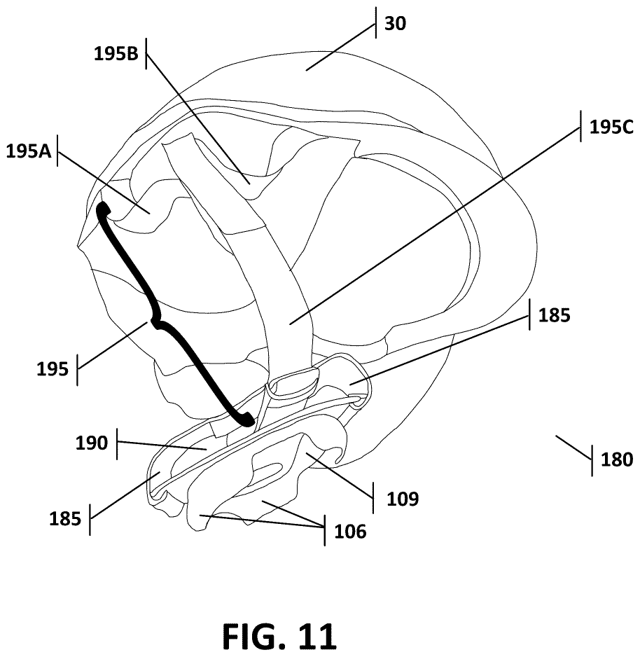

FIG. 11 provides a top perspective view of a Y-type helmet strap 195, which is the most common style of helmet strap, being inserted through the back loop 190 formed by the two fastener straps 185. There may be more than one layer to the fastener straps 185, such that, as the lower vertical portion 195C of the helmet Y-type strap 195 is pulled down through the back loop 190 behind the headset assembly 180, the fastener straps 185 would eventually encounter the upper left portion 195A and upper right portion 195B of the same Y-type helmet strap 195. With more layers of fastener straps 185, the other strap portions 195A, 195B can also be fastened to back of the headset assembly 180 with a secure and accurate positioning.

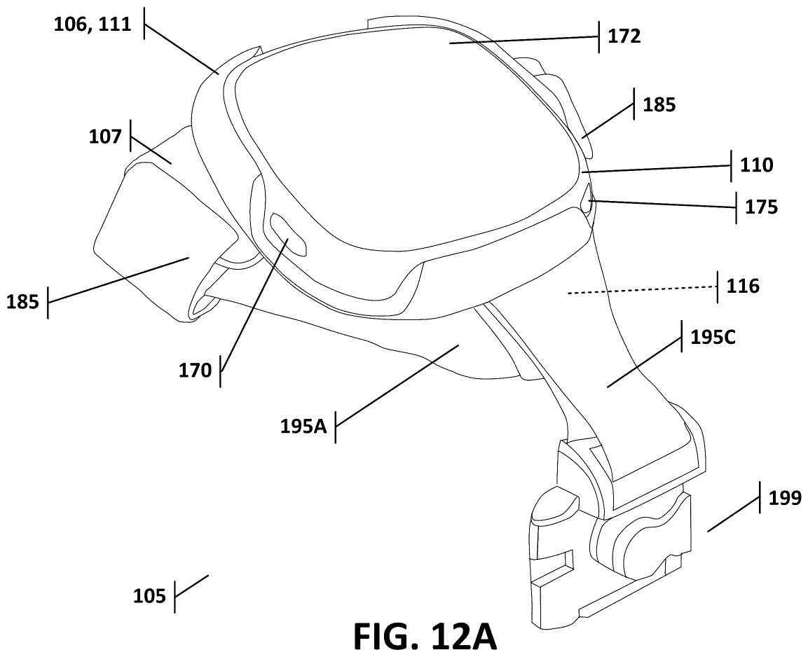

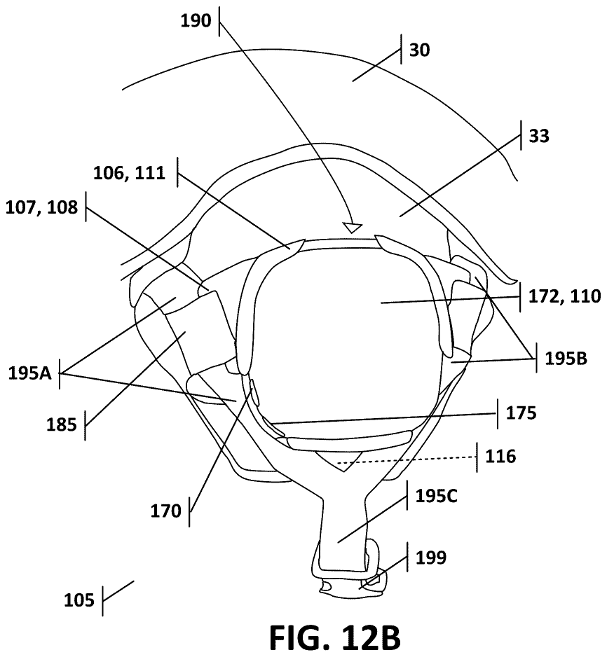

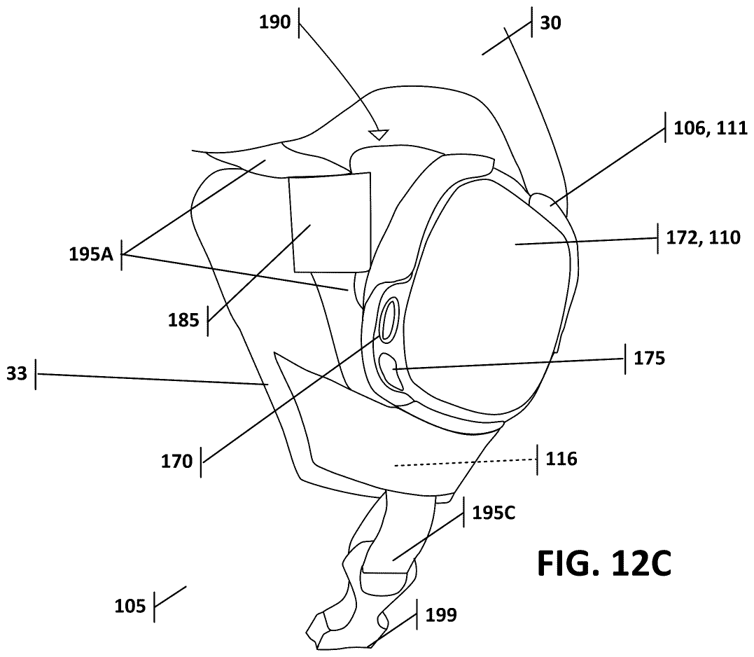

Next, FIG. 12A shows the entire headset system 105 installed on a Y-type helmet strap 195. For the sake of more clearly illustrating the features, the helmet 30 has been omitted from the drawing. Due to the top perspective view, only the upper left portion 195A of the helmet strap 195 and the lower vertical portion 195C leading down to a helmet strap buckle 199 can be seen. The view of the upper right portion 195B of the helmet strap 195 and the tongue protrusion 116 behind the Y-style junction of strap portions 195A, 195B, 195C are obstructed. However, the helmet strap portion 195A has been pulled through a loop formed by the fastener strap 185. The earpiece or communication unit 110 sits housed within the enclosure 106 and contacts the flexible enclosure overlay 111. There are grooves on the sides of the enclosure 106 that allow access to one or more ports 170 and one or more UI buttons 175. The earpiece or communication unit 110 may also feature a display screen 172 on its front side. The tongue protrusion 116 is not visible and sits because the lower vertical portion 195C of the helmet strap 195, allowing some part of the helmet strap 195 into its front notch 119.

FIG. 12B depicts the fully installed headset system 105. When installed as described, the headset system sits outside the ear flaps 33 of the helmet 30. The tongue protrusion 116 sits behind the lower portion of the helmet strap 195. This view shows both upper diagonal portions 195A, 195B of the Y-type strap fitting snugly against the sides of the back loop 190, held in place by fastener straps 185 inserted into the strap guides 108. FIG. 12C shows a variation, where there is a helmet strap portion that goes horizontally across the lower portion of the ear flap 33. Here, the tongue protrusion 116 is inserted behind the horizontal strap, as well as the behind the lower vertical portion 195C of the helmet strap leading to the buckle 199.

Taking all the salient features of the headset system 105 together, the headset system 105 comprises: an earpiece or communication unit 110, and a headset assembly 180. The headset assembly 180 comprises an enclosure 106 for the earpiece or communication unit 110, itself comprising a cavity 109 for receiving the earpiece or communication unit 110 and comprising one or more cutouts for receiving snap-fit or friction-fit connectors; a strap organizer piece 107 attached to the enclosure 106 and comprising a first and a second strap insert guide 108; and one or more fastener straps 185 that have a first fastener surface 187 and a second fastener surface 188, wherein the first fastener surface 187 and the second fastener surface 188 mate with one another. The earpiece or communication unit 110 securely mates with the enclosure 106 via a snap fit or a friction fit, and the first and second fastener surfaces 187, 188 secure the headset assembly 180 and the headset system 105 to one or more helmet straps (195, 195A, 195B, 195C) after the one or more helmet straps is inserted through the back loop 190 created by the one or more fastener insert straps 185. These features are supported by FIGS. 7A-7D and 11-12C.

In this headset system 105, the earpiece or communication unit 105 may comprise one or more ports 170, such as a USB-C port, which can be used for downloading data and/or for charging the battery 44 inside the earpiece or communication unit 105. The earpiece or communication unit 105 could also comprise one or more user interface buttons 175 accessible by the user when wearing the headset system 105. Although FIGS. 7A-12C depicted only one earpiece or communication unit 110 at a time, it is to be understood that the headset system 105 may comprise one earpiece or two.

If there are two earpieces 110, the configuration of the headset system 105 may be any one of the following options, as preset/default or selected by the user. One side could be on and the other side is off, and one user accesses the headset system 105. The two earpieces 110 could both be on and used by one user. They could also both be on and synchronized to two users who each has one communication unit 110, or in other words, each communication unit 110 can operate independently of the other. The headset system 105 can also allow the user to select whether to enable the second earpiece or communication unit 110 to connect to the same audio source as the first earpiece or communication unit 110. These configurations allow the user to give one communication unit 110 to a second user, and the ear pieces can operate as two distinct communication units 110. The two users can communicate between themselves, share music or data such as navigation data or skiing data etc., and the second user can operate the communication unit 110 as a standalone, for example, to connect to a smartphone. When the two communication units are separated for two users they can be manually or automatically paired. When the two communication units 110 are reunited, they return to the basic operation mode, stereo. The headset system 105 may further receive and transmit audio signals wirelessly and pair with other electronic devices, such as a phone. In summary, the headset system 105 may have at least four states or configurations: (1) right communication unit 110 is ON and left communication unit 110 is ON, both used by one user in stereo mode; (2) right side communication unit 110 is ON and left side communication unit 110 is OFF, used by one user in mono mode; (3) left side communication unit 110 is ON and right side communication unit 110 is OFF, used by one user in mono; and (4) right side communication unit 110 is ON and left side communication unit 110 is ON, each side is used by a separate users. The user can shift from one configuration to another based upon the input from one or more user interface buttons 175 located on the communication unit 110 or using an application on the user's smartphone or using voice commands. The connections described herein of the communication unit to a smartphone can also be to additional devices such as a smart watch, smart glasses, a smart helmet etc.

The tongue protrusion 116 taught by the present invention is advantageous since Y-type helmet straps are commonplace. The strap organizer piece 107 would have a tongue protrusion 116 that secures to the vertical lower portion 195C of a Y-type helmet strap 195 extending towards the helmet wearer's chin. Moreover, the tongue protrusion 116 may have a notch 119 that allows the lower vertical portion 195C of a Y-type helmet strap 195 to fit securely into the notch 119 and stabilize the positioning of the headset system 105.

Another optional improvement on the strap organizer piece 107 is providing a fastener surface 189 that mates with one of the fastener surfaces 187, 188 on the fastener strap 185. Having more points where the fastener surface is usable can provide more loops or loops that fit more tightly, which helps secure the position of the headset system 105. The first and second fastener surfaces 187, 188 can be made of a hook-and-loop fastener. The first fastener surface 187 may be a male hook-and-loop fastener surface, and the second fastener surface 188 may be a female hook-and-loop fastener surface. Variations for fastener surfaces include hook and loop fasteners, buttons and buttonholes, snaps, and magnets, and one or more of these options may be used for the fastener straps 185 and surfaces 187, 188.

Of the options for the enclosure 106 for the earpieces or communication unit 110, one is to have an enclosure keyhole cutout 118 to minimize the obstruction of sound between the headset system 105 and the user's ear. As a further variation, the earpiece or communication unit 110 could have a protrusion in the speaker portion, which extends through the enclosure keyhole cutout 118 towards the user's ear when the earpiece or communication unit 110 securely mates with the enclosure 106.

The enclosure 106 can be made of a flexible material, such as from thermoplastic elastomers (TPE). If it is not made entirely of a flexible material, the enclosure 106 can be made of a rigid material and further comprises a plurality of cutouts (124A) for mating with a flexible friction-fit or snap-fit flexible enclosure overlay 111. The headset system 105 can then further comprise a flexible enclosure overlay 111 having a plurality of connectors or protrusions (124B) positioned to mate with the enclosure 106. The earpiece or communication unit 110 contacts the flexible enclosure overlay 111 via friction when the earpiece or communication unit 110 securely mates with the enclosure 106. The headset system 105 can also provide more snap-fit or friction-fit connections 117 between the flexible enclosure overlay 111 and the strap organizer piece 107, formed from connectors 112.

While operations may be depicted in the drawings in a particular order, this should not be understood as requiring that such operations be performed in the order shown or in sequential order, or that all illustrated operations be performed, to achieve desirable results. Moreover, the separation of various system components in the embodiments described in this patent document should not be understood as requiring such separation in all embodiments. Only a few implementations and examples are described and other implementations, enhancements, and variations can be made without departing from the scope and spirit of this invention, based on what is described and illustrated in this patent document.

While this patent document contains many specifics, these should not be construed as limitations on the scope of any invention or of what may be claimed, but rather as descriptions of features that may be specific to embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

1.-18. (canceled)

19. A headset system for use with a helmet having one or more straps, the headset system comprising:
an communication unit; and
a headset assembly comprising:
an enclosure defining a cavity configured to receive the communication unit;
a strap organizer attached to the enclosure and comprising first and second strap insert guides; and
one or more fastener straps each having a first fastener surface and a second fastener surface configured to mate with each other;
wherein:
the one or more fastener straps are insertable into the first and second strap insert guides to form at least one back loop when the first and second fastener surfaces mate;
the communication unit mates with the enclosure via a snap fit or friction fit; and
the first and second fastener surfaces are configured to secure the headset assembly to the one or more helmet straps after insertion through the back loop.

20. The headset system of claim 19, wherein the communication unit comprises one or more ports for data transfer or battery charging.

21. The headset system of claim 19, wherein the communication unit comprises one or more user interface buttons accessible during use.

22. The headset system of claim 19, wherein the strap organizer further comprises a tongue protrusion configured to secure to a lower vertical portion of a Y-type helmet strap.

23. (canceled)

24. The headset system of claim 19, wherein the enclosure defines a keyhole cutout for sound transmission.

25. The headset system of claim 24, wherein the communication unit comprises a speaker protrusion configured to extend through the keyhole cutout toward a user's ear.

26. The headset system of claim 19, wherein the enclosure comprises a flexible material.

27. The headset system of claim 19, further comprising a flexible enclosure overlay, wherein the enclosure comprises a rigid material defining cutouts for mating with the flexible enclosure overlay.

28. The headset system of claim 27, wherein the flexible enclosure overlay comprises protrusions positioned to mate with the cutouts.

29. The headset system of claim 28, wherein the communication unit contacts the flexible enclosure overlay via friction.

30. (canceled)

31. The headset system of claim 19, wherein a back surface of the strap organizer comprises a fastener surface configured to mate with the first or second fastener surface.

32. The headset system of claim 19, comprising two communication units, one for each ear.

33. (canceled)

34. (canceled)

35. The headset system of claim 19, wherein the system is configured to wirelessly receive and transmit audio signals and pair with external electronic devices.

36. The headset system of claim 21, wherein the system supports multiple operational configurations selectable via the one or more user interface buttons.

37. (canceled)

38. The headset system of claim 19, wherein the enclosure defines microphone apertures and further comprises a microphone windscreen of porous acoustic material disposed over the apertures to attenuate wind noise.

39. The headset system of claim 38, wherein the porous acoustic material is open-cell foam, fabric, sponge, or synthetic fur.

40. The headset system of claim 38, wherein the microphone windscreen is on an exterior surface of the enclosure opposite the cavity.

41. The headset system of claim 38, wherein the microphone windscreen is on an interior surface of the enclosure adjacent the cavity.

42. The headset system of claim 38, further comprising a windscreen support retaining the microphone windscreen in alignment with the apertures.

43. (canceled)

44. The headset system of claim 19, wherein the communication unit includes at least one of the following: automatic gain control, wind reduction algorithms, and active noise control.
